(19) United States
(12) Patent Application Publication
(10) Pub. No.: US 2002/0164520 A1
(43) Pub. Date: Nov. 7, 2002

(54) Fuel cells through molecular recognition processes

(76) Inventors: Atsushi Mizusawa, Osaka (JP); Tazuko Mizusawa, Osaka (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 09/846,976

(22) Filed: May 2, 2001

(51) Int. Cl. H01M 4/86; H01M 4/90; H01M 4/88

(52) U.S. Cl. 429/40; 502/101; 429/13

(57) ABSTRACT

A novel fuel cell uses carbohydrates, alcohols or other organic fuels as its fuel to generate electricity via an electrochemical reaction. To catalyze the electrochemical reaction in the fuel cell and reduce the likelihood of the anode of being poisoned by by-products from the eletrochemical reaction and impurities in the fuel, an anode material with molecular recognition sites for the fuel is used in the fuel cell. The anode material is synthesized using a hydrothermal synthesis technique with the fuel as a template. A method of generating electricity using this fuel cell is also disclosed.

### BACKGROUND OF THE INVENTION

A. Field of the Invention

This invention relates to a fuel cell, which generates electricity directly from common environmentally friendly fuels via an electrochemical process, and employs molecular recognition sites for the fuel used in the fuel cell.

B. Description of the Prior Art

The most efficient technique so far of converting the chemical energy of a fuel into electric energy is the conversion of fuel into electricity in fuel cells. In a typical fuel cell, the fuel is consumed at the anode of the cell to form oxidized products. An oxidizing agent such as air or oxygen is reduced into water, components of water, or other materials such as hydroxide ions at the cathode of the cell. At same time, electricity is generated from the cell in a form of an electric current flowing through a closed circuit between the cathode and the anode.

The advantage of these fuel cells is that energy transformation can be carried out at a low temperature, and that theoretically, all the available free energy change (Gibbs' free energy) is converted into electric energy, thereby preventing the power losses which typically occur in processes in which differences in temperature are utilized, for example in a Carnot heat engine.

Most fuel cells use high purity hydrogen as the fuel. In more rare cases, other fuels have been used in a fuel cell. Hertl and Schaeffler (U.S. Pat. No. 4,578,323) use a hydroxylic compound, such as an alcohol and a sugar, as the fuel for a fuel cell. However, in Hertl and Schaeffler, the fuel is oxidized through an anaerobic oxidation process, which does not fully take advantage of the chemical energy, using a quinone as the oxidizing agent. Most chemical energy contained in the hydroxylic compound is not fully utilized.

There are two important reasons for the wide use of hydrogen instead of the more readily available hydrocarbons or carbohydrates. The first reason is that most anode materials could not effectively catalyze the electrochemical reaction of hydrocarbons and carbohydrates to generate energy. The second reason is that the by-products from the electrochemical reaction using carbohydrates and hydrocarbons as the fuel, as well as impurities in the fuel may poison the anode and render the fuel cell inoperative. Some attempts have been made to address the second problem. For example, monosaccharides were added into a solution in contact with the anode noble metal to form a coating of oxidized monosaccharides on the anode metal (see Mizusawa, A.; Itaya, K., Jpn. Kokai Tokkyo Koho (1999), JP 11214020 Heisei). However, none of the previous fuel cell technologies were able to use carbohydrate as a fuel to generate electricity efficiently.

Molecular recognition is known in nature. For example, enzymes catalyze biochemical reactions via a molecular recognition process. Several publications have also discussed the possibility of using a molecular recognition process to prepare materials that are capable of recognizing certain specific molecules. For example, molecular recognition was used to detect and measure the concentration of certain molecules (see Mizusawa, A, Jpn. Kokai Tokkyo Koho (1998), JP 10054823).

Various embodiments of the present invention are directed to overcome one or more of the problems encountered in the prior art which has been discussed above.

### SUMMARY OF THE INVENTION

It is accordingly an object of certain embodiments of the current invention to provide a fuel cell, which can use carbohydrates and other common environmentally friendly organic fuels to generate electricity efficiently. It is also an object of certain embodiments of the current invention to provide a fuel cell with a prolonged operation life in comparison with prior art fuel cells using carbohydrates and other organic fuels as the fuel. It is a further object of certain embodiments of this invention to provide a process to produce an anode material, which contains molecular recognition sites, to be used in a fuel cell anode. It is another object of certain embodiments of this invention to provide a method to generate electricity using a fuel cell which employs molecular recognition sites for the fuel.

According to one embodiment, the fuel cell of the invention comprises a cathode, an anode and an electrolyte in contact with the cathode and anode, wherein the anode is wholly or partially made from a material, which has molecular recognition sites for the fuel used in the fuel cell. Those molecular recognition sites in the anode can interact with the fuel to promote the electrochemical reaction of the fuel to generate energy. As a result, the anode material may only interact with certain fuels, for example, specific carbohydrates or specific other suitable organic fuels through molecular recognition. Other molecules, which include by-products from the electrochemical reaction and impurities from the fuel or any other sources will generally not interact with the anode. Therefore, the likelihood that the anode will be poisoned by exposure to the by-products and impurities in the fuel is substantially reduced. This may permit a longer operation life for the fuel cell.

In another embodiment, the present invention relates to a novel process of making an anode material with molecular recognition sites for a fuel used in a fuel cell. In the process, a metal compound is dissolved or dispersed in a solution containing a complexing agent and a fuel to form a metal complex. The formed complex contains molecular recognition sites for the fuel.

In a further embodiment, the present invention relates to a novel method to generate electricity using a fuel cell in accordance with the present invention.

The construction and method of operation of the invention, however, together with additional objects and advantages thereof will be best understood from the following description of specific embodiments when read in connection with the accompanying drawing.

### BRIEF DESCRIPTION OF THE DRAWINGS

FIG. 1 is an illustrative diagram of the interaction process between tetrahedrons and octahedrons during the hydrothermal synthesis according to the invention.

FIG. 2 is a diagrammatic, cross-sectional view of one type (a octahedral-tetrahedral framework) of the supramolecule according to the invention.

FIG. 3 is a diagrammatic, cross-sectional view of a fuel cell according to the invention.

FIG. 4 is an illustrative diagram of the interaction process between tetrahedrons and pyramids during the hydrothermal synthesis according to the invention.

FIG. 5 is an illustrative diagram of the interaction process between tetrahedrons and tetrahedrons during the hydrothermal synthesis according to the invention.

FIG. 6 is a diagrammatic, cross-sectional view of another type (a pyramidal-tetrahedral framework) of the supramolecule according to the invention.

FIG. 7 is a diagrammatic, cross-sectional view of a third type (a tetrahedral-tetrahedral framework) of the supramolecule according to the invention

### DESCRIPTION OF THE PREFERRED EMBODIMENTS

In a first embodiment, the present invention relates to a fuel cell which comprises a cathode, an anode and an electrolyte which is in contact with both the anode and the cathode. The anode is made from a novel anode material, which is a metal complex containing molecular recognition sites and optionally being produced by a hydrothermal synthesis.

Molecular recognition in the current context is defined as complementarity between the host and guest. For this invention, the host is the anode material of the fuel cell, whereas the guest is the fuel for the fuel cell. This invention uses the definition of complementarity from the reference book: Steed, J. W. and Atwood, J. L., “Supramolecular Chemistry”, John Wiley & Sons, 2000, page 13, as follows: “In order to bind, a host must have binding sites that are of the correct electronic character (polarity, hydrogen bond, donor/acceptor ability, hardness or softness, etc.) to complement those of the guest. Hydrogen bond donors must match to acceptors; Lewis acids must match Lewis bases. Furthermore, those binding sites must be spaced out on the host in such a way as to make it possible for them to interact with the guest in the binding conformation of the host molecule. If a host fulfils these criteria, it is said to be complementary.” Those binding sites on the host are therefore called molecular recognition sites.

Hydrothermal synthesis is a synthesis method that has been described in a few publications (see Lii, K-H, et al, Chemical Materials, 1998, 10, pp 2599; Lee, M-Y, et al Chemical Materials, 1999, 11, pp3588; Feng, P. et al, Journal of American Chemical Society, 1997, 119, pp 2497). Here are the steps involved in the hydrothermal synthesis in the context of the current invention.

The first step of the hydrothermal synthesis process involves dispersing (for example, by mineralizing) or dissolving a metal or a metal compound in a high pressure vessel which contains a suitable solvent and a complexing agent. The synthesis process is carried out in the presence of the fuel for use in the fuel cell. The mixture, which includes the fuel, the metal or the metal compound, the complexing agent and the solvent, is then heated up to a suitable reaction temperature for a suitable reaction time. The fuel has a specific molecular form and charge. Various non-covalent interactions occur among the fuel, the metal or the metal compound, and the complexing agent. The resultant metal complex contains molecular recognition sites, which the fuel fits into after the crystallization of this complex. The precipitated crystals can be separated from the reaction mixture by filtration, decanting or other common techniques which can separate liquid from solid.

The separated metal complex crystals, which contain the molecular recognition sites for the fuel are the product which can be used as an anode material in a fuel cell. The crystal products with the molecular recognition sites can be further activated by oxidizing the fuel still trapped in the crystals electrochemically, mechanically or thermally before being used as an anode material. After activation, these sites can continuously accept additional fuel to promote the electrochemical oxidation of fuel molecules to generate electricity. The anode material prepared by this process is called a “hydrothermally prepared” anode material.

The metal or metal compound used in this invention includes, but is not limited to, aluminum (Al), titanium (Ti), vanadium (V), chromium (Cr), manganese (Mn), iron (Fe), cobalt (Co), nickel (Ni), copper (Cu), zinc (Zn), gallium (Ga), germanium (Ge), niobium (Nb), molybdenum (Mo), ruthenium (Ru), rhodium (Rh), palladium (Pd), silver (Ag), cadmium (Cd), indium (In), cesium (Cs), tantalum (Ta), tungsten (W), compounds containing one or more of these metals and mixtures thereof. The preferred metal or metal compound includes one or more of titanium (Ti), vanadium (V), chromium (Cr), manganese (Mn), iron (Fe), cobalt (Co), nickel (Ni), copper (Cu), zinc (Zn), gallium (Ga), germanium (Ge), niobium (Nb), molybdenum (Mo), indium (In), tantalum (Ta), tungsten (W), compounds containing one or more of these metals and mixtures thereof. The most preferred metal and metal compound includes titanium (Ti), vanadium (V), chromium (Cr), manganese (Mn), iron (Fe), niobium (Nb), molybdenum (Mo), tantalum (Ta), tungsten (W), compounds containing one or more of these metals and mixtures thereof.

The complexing agent, which may be used in this invention, may be selected from arsenic acid, boric acid, germanic acid, oxalic acid, phosphoric acid, silicic acid, calcium arsenate, potassium arsenate, sodium arsenate, sodium bromate, ammonium germanate, magnesium germanate, ammonium hexafluorogermanate, germanium oxide, ammonium phosphate, calcium phosphate, magnesium phosphate, potassium phosphate, sodium phosphate, sodium silicate, sodium tetraborate, sodium vanadate dihydrate, and mixtures thereof. Preferably the complexing agent is a covalent complexing agent. More preferably the complexing agent is selected from the group consisting of arsenic acid, oxalic acid, phosphoric acid, germanium oxide, potassium phosphate, sodium phosphate, sodium vanadate dihydrate, and mixtures thereof which have suitable complexing properties. Most preferably the complexing agents are arsenic acid and phosphoric acid.

The fuel preferably includes one or more of methanol, ethanol, propanol, butanol tertbutanol, carbohydrates and mixtures thereof. Suitable carbohydrates include fructose, galactose, glucose, lactose, mannose, sucrose and mixtures thereof. More preferably, the fuel includes one or more of methanol, ethanol, glucose, fructose and mixtures thereof. Most preferably the fuel is glucose.

The suitable reaction temperature for the hydrothermal synthesis process ranges from 0° C. to 400° C. Preferably the reaction temperature ranges from 0° C. to 200° C. Most preferably the reaction temperature ranges from 100° C. to 200° C.

The suitable reaction time for the process is typically between 1 hour and 12 days. More preferably the reaction time is between 4 hours and 7 days. Most preferably the reaction time is between 1 day and 7 days.

The mole ratio of the fuel to the other components, which include both the metal and the complexing agent but do not include the solvent, preferably ranges from 10:1 to 1:100. More preferably this mole ratio ranges from 5:1 to 1:50. Most preferably this mole ratio ranges from 3:1 to 1:30.

The mole ratio between the metal and the complexing agent ranges from 10:0.1 to 1:200. More preferably this mole ratio ranges between 3:1 to 1:100. Most preferably, this mole ratio ranges between 2:1 to 1:50.

The suitable solvent may be selected from water, methanol, ethanol, propanol, butanol, mixtures thereof and azeotropes thereof. More preferably the solvent may be selected from water, ethanol, azeotropes thereof and mixtures thereof. Most preferably the solvent is water.

The mole ratio between the solvent and the total moles of the reactants, which include the metal or the metal compound, the fuel and the complexing agent, ranges from 1:1 to 2000:1. More preferably this mole ratio ranges from 5:1 to 1000:1. Most preferably this mole ratio ranges from 10:1 to 500:1.

Preferably the interaction between the metal and the metal compound, the fuel and the complexing agent is a self-assembly interaction. The self-assembly interaction is a well known interaction to a person skilled in the art.

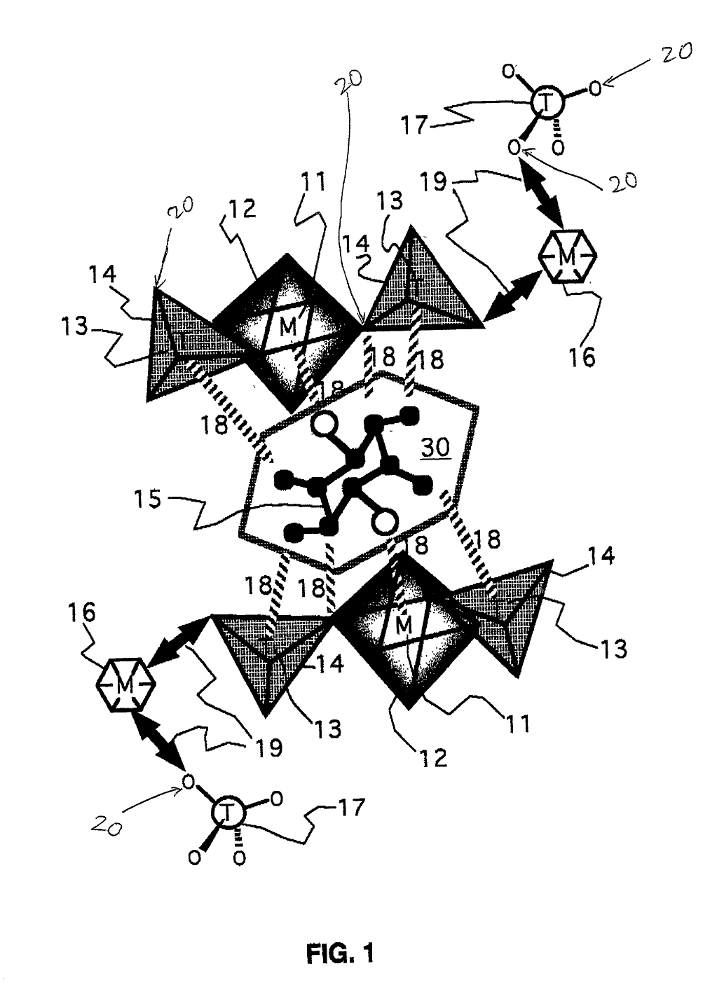

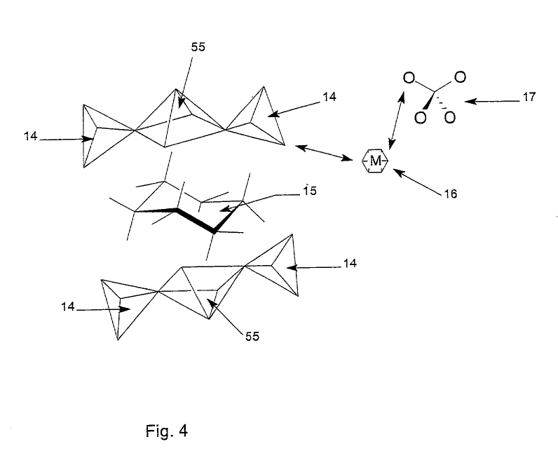

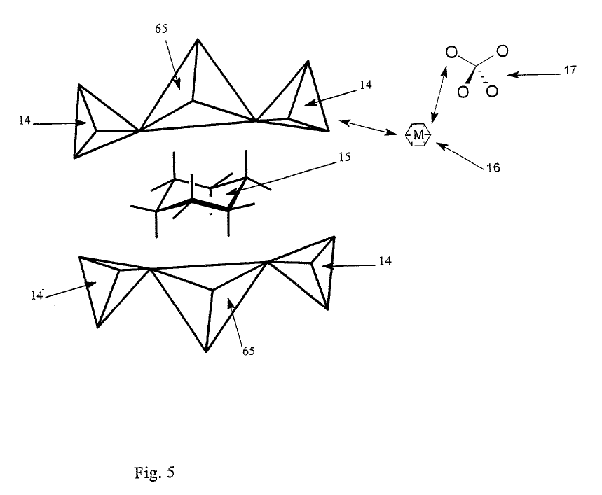

The complexing agent is also preferably selected from arsenic acid, germanic acid, phosphoric acid, arsenate, germanate, phosphate and other suitable salts which exist in aqueous solution in the form of tetrahedron structures. FIG. 1 illustrates the formation of octahedron structures and the covalent bonding interactions between tetrahedrons and octahedrons in a hydrothermal synthesis. Typically, arsenic atoms, germanium atoms, or phosphor atoms occupy centers 13 of tetrahedrons 14 and 17 as shown in FIG. 1. Oxygen atoms generally occupy comers 20 of the tetrahedrons. The metal atoms from the metal compound preferably interact with the oxygen atoms in the arsenic acid, germanic acid, phosphoric acid, arsenate, germanate, phosphate and other suitable salts to form octahedrons 12 with the metal atoms being centers 11 of octahedrons 12 and the oxygen atoms 20 being at the corners of octahedrons 12. Simultaneously, various kinds of non-covalent interactions 18 occur between the fuel 15 and the octahedral-tetrahedral complex. The interactions are defined as the complementarity between the host, in this case the octahedral-tetrahedral complex, and the guest, in this case, the fuel 15. Alternatively, the tetrahedrons 17 from the complexing agent can interact with the metal atoms 16 from the metal compound to form pyramidal structures (55 in FIG. 4) or tetrahedral structures (65 in FIG. 5). In a similar manner as described above, tetrahedral-tetrahedral complexes (FIG. 5) or pyramidal-tetrahedral complexes (FIG. 4) form via various kinds of non-covalent interactions between the fuel (15) and the pyramidal structures (55 in FIG. 4) or the tetrahedral structures (65 in FIG. 5).

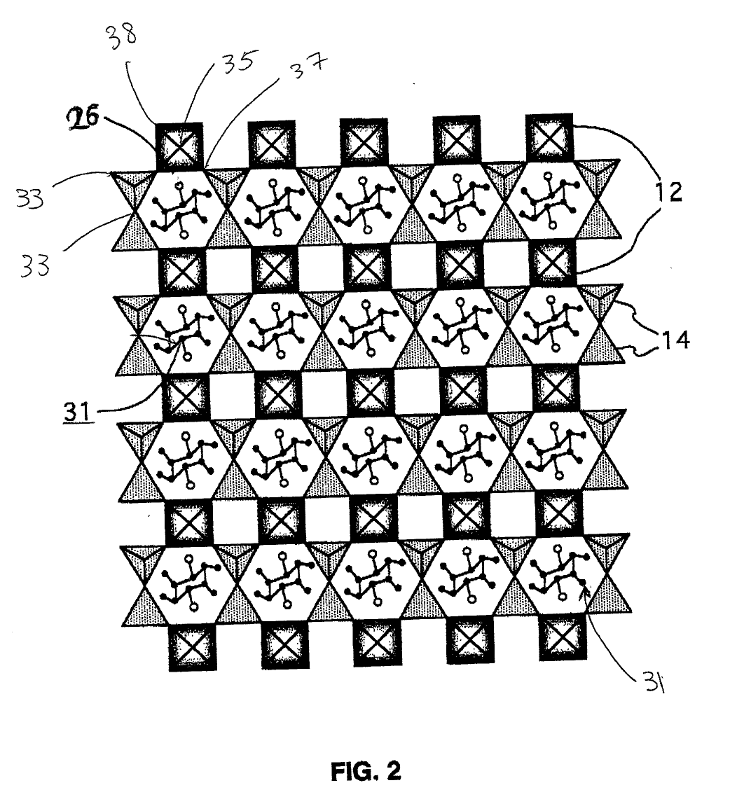

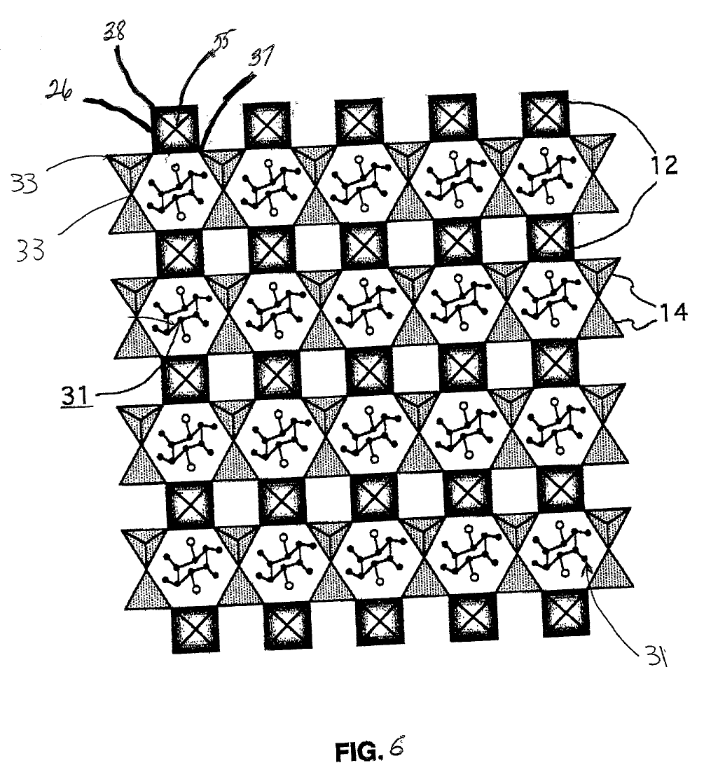

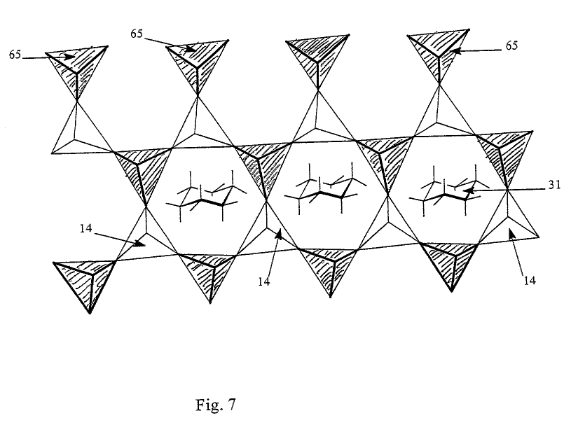

The metal complex formed by the hydrothermal synthesis, which can be used as an anode material, is preferably a supramolecule, which is in the form of chains, layers or a three-dimensional open frame structure, all of which contain a plurality of molecular recognition sites for the fuel. The supramolecule is a well known structure to a person skilled in the art. Beer (see Beer, P. D., et al, Supramolecular Chemistry, Oxford Science Publication, 1999) and Steed (see Steed, J. W. et al, Supramolecular Chemistry, John Wiley & Sons, 2000) have defined the supramolecule. FIG. 2 illustrates a cross-sectional view of a schematic representation of part of one type of the supramolecule. Metal atoms 35 from the metal compound form octahedrons 26 and 12 via interaction with oxygen atoms 37 of arsenic acid, germanic acid, phosphoric acid, arsenate, germanate, phosphate and other suitable salts, which typically have the shape of a tetrahedron. Those octahedrons 12 and tetrahedrons 14 are covalently bonded through oxygens 37 and maintain non-covalent interactions with fuel molecules 31 via molecular recognition sites which are complementary for the fuel molecules 31 to form a supramolecule as illustrated in FIG. 2. Therefore, the anode material is also preferably an octahedral-tetrahedral framework. Alternatively, the anode material can also be a tetrahedral-tetrahedral framework (FIG. 7) or a pyramidal-tetrahedral framework (FIG. 6), which is formed in a similar way. Furthermore, the formed anode material is preferably an inorganic material.

Activating the anode material electrochemically means using this anode material as an anode of a fuel cell with all other necessary components, which includes a cathode and an electrolyte, connecting the cathode and the anode using a closed conductive circuit between the cathode and the anode. An oxidizing agent is added to the cathode section of the fuel cell to oxidize the fuel still in the anode material to activate the anode material with or without external electric power being applied on the closed circuit.

Activating the anode material thermally means heating this material to an elevated temperature to decompose or evaporate the fuel molecules still in the anode material. The temperature of the heating process can range from 100° C. to 700° C., more preferably from 150° C. to 600° C. and most preferably from 200° C. to 500° C. After heating, the anode material is ready for use as the anode in a fuel cell. Heating may be carried out using the common means of heating known to a person skilled in art, such as an oven, infrared radiation, a thermal well, etc.

Activating the anode material mechanically means grinding the material to very fine particles so that the fuel in the anode material will be quickly released from the large surface area of the particles created by grinding. Grinding may be accomplished using common industrial grinding methods for solid materials.

Preferably the oxidizing agent used for the electrochemical activation is oxygen, hydrogen peroxide, air, other oxygen containing gases or mixtures thereof. More preferably the oxidizing agent is oxygen, air or mixtures thereof.

The anode material prepared using the above-described procedure can be used alone as an anode or can be used in combination with other conductors. To use it alone, the anode material can be loaded into the anode section of a fuel cell in contact with electrolyte. The anode material can be used in combination with one or more other conductors by packing them together in a fuel cell or coating the other conductor(s) with the anode material and inserting the coated conductor(s) into the fuel cell.

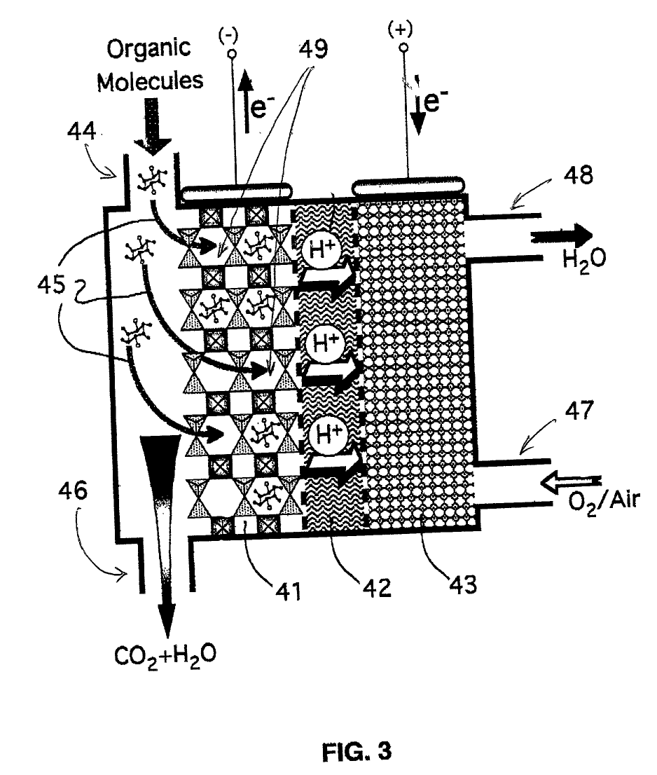

A fuel cell according to the present invention is illustrated in FIG. 3. Anode 41 contains an anode material. The anode material contains a plurality of molecular recognition sites 49, which promote the electrochemical reaction of fuel 45. Fuel 45 flows into the fuel cell through anode inlet 44 to the anode section of the fuel cell to be in contact with anode 41. Anode 41 interacts with the fuel, promotes the electrochemical reaction of the fuel and converts the fuel into carbon dioxide and water while generating protons. The generated protons pass thorough electrolyte 42 and reach cathode 43. Cathode 43 absorbs the protons and reduces an oxidizing agent from cathode inlet 47. The reduction products flow out the fuel cell through cathode outlet 48.

Anode 41 is in part an anode material, which contains a plurality of molecular recognition sites. More preferably anode 41 is at least in part an anode material made by the hydrothermal process described above, which contains molecular recognition sites for the fuel. Most preferably anode 41 is made completely of an anode material made by the hydrothermal process described above, which contains molecular recognition sites for the fuel.

Suitable electrolytes 42 for the fuel cell are well known to skilled persons (see U.S. Pat. No. 4,060,672, Von Alphen).

The materials which can be used as cathode 43 in the fuel cell are also well known to skilled persons.

The anode material is selective for a specific fuel because it interacts with the fuel through molecular recognition. A complicated organic fuel such as glucose can be used as a fuel for the fuel cell as long as the anode material is capable of catalyzing the electrochemical reaction of glucose. The by-products of the oxidation reaction and impurities in the fuel will generally not interact with the anode and will not be absorbed by the anode because such molecules (including both the by-products and the impurities) will generally not have the proper structure to interact with the molecular recognition sites. As a result, it is less likely that the anode will be poisoned by the by-products from the fuel cell and impurities in the fuel. A fuel cell with an anode containing an anode material with molecular recognition sites will, therefore, generally have a prolonged operation life in comparison with conventional fuel cells using carbohydrates or other organic material as the fuel.

According to another embodiment of the present invention, electricity can be generated in a continuous operation. A fuel, for which the anode material has molecular recognition sites, is employed in the anode section of a fuel cell. At the same time, an oxidizing agent is added to the cathode section of the fuel cell to be in contact with the cathode. An electrolyte is employed to electrically connect the anode and the cathode. Electricity will be generated by the fuel cell. In order to continuously generate electricity, the molecular recognition sites on the anode may be regenerated upon depletion of the fuel on the anode. Additional fresh fuel flowing from the anode inlet will restart the electrochemical reaction to generate additional electricity. Therefore, a continuous flow of fuel to the anode section and of oxidizing agent to the cathode section will continuously generate electricity.

According to a further embodiment of the present invention, electricity can also be generated in a batch operation. A fuel, for which the anode material has molecular recognition sites, may be added to the anode section of the fuel cell to be in contact with the anode. At same time, an oxidizing agent may be added to the cathode section of the fuel to be in contact with the cathode. An electrolyte is employed to electrically connect the anode and cathode. Electricity will be generated by the fuel cell. Upon depletion of the fuel or the oxidizing agent, generation of electricity will come to a halt. If additional electricity is needed, additional fuel is added to the anode section of the fuel cell or/and additional oxidizing agent is added to the cathode section of the fuel cell. The fuel cell may also be optionally activated between batch operations. The electricity generation will resume and continue until depletion of the fuel or the oxidizing agent.

The fuel cell preferably, operates at a temperature below 120° C. The fuel cell most preferably operates at a temperature between 60° C. and 100° C.

The fuel used in the fuel cell, preferably includes, but is not limited to, methanol, ethanol, propanol, butanol, tert-butanol and carbohydrates. The carbohydrates include, but are not limited to, fructose, galactose, glucose, lactose, mannose, sucrose, and mixtures thereof More preferably, the fuel includes methanol, ethanol, fructose, glucose and mixtures thereof. Most preferably, the fuel is glucose.

Preferably the oxidizing agent used for generating electricity is oxygen, hydrogen peroxide, air, other oxygen-containing gases or mixtures thereof More preferably, the oxidizing agent is oxygen, air or mixtures thereof.

The voltage of the fuel cell can be calculated from the electric potential of the electrochemical reaction. The calculation method can be found in most physical chemistry textbooks. Under typical conditions, the voltage is equal to or close to the standard electrode potentials of the electrochemical reaction E°, which can be calculated from Gibbs Free Energy of using the equation of ΔG=−nFE′, wherein ΔG is the Gibbs Free Energy, n is the number of electrons transferred during the electrochemical reaction, and F is the Faraday's Constant. When glucose is used as the fuel and oxygen is used as the oxidizing agent, the output voltage of the fuel cell is around 1.24V.

The invention will now be illustrated by the following example.

### EXAMPLE 1

### Preparation of an Anode Material Based on Molybdenum Oxide Using Glucose as the Organic Templating Material

To a 50 ml Parr reactor, 5 mmole of H₃AsO₄, and 2000 mmole of water are added. After 30 minutes, 3 mmole of MoO₃ is added to the reactor. After the mixture being mixed for 5 minutes, 5 mmole of glucose is further added to the reactor. The mixture in the reactor is then mixed for additional 10 minutes. The reactor is sealed and heated up to 165° C. using a heating mantle for 2 days. As a result of the reactor being cooled down to room temperature, crystals form in the reactor. The formed crystals are washed with water and isolated in 20% yield based on Mo. The crystals can be used as an anode material as is or can be further activated thermally before being packed into a fuel cell. The crystals are activated by heating the crystals to 400° C. for 12 hours under a nitrogen atmosphere.

It will thus be seen that the objects set forth above, among those made apparent from the preceding description, may be efficiently attained by certain embodiments of the present invention, and, since certain changes may be made in carrying out the above method and in the fuel cell set forth without departing from the spirit and scope of the invention, it is intended that all matter contained in the above description and shown in the accompanying drawing shall be interpreted as illustrative and not in a limiting sense.

The scope of the invention is to be determined from the claims appended hereto.

We claim:

1. A fuel cell comprising an anode, a cathode and an electrolyte in contact with said anode and said cathode, wherein said anode comprises an anode material having a plurality of molecular recognition sites.

2. A fuel cell as claimed in claim 1, wherein said anode material comprises a supramolecule, which is selected from the group consisting of:
a plurality of chains, wherein each said chain includes a plurality of molecular recognition sites,
a plurality of layers, wherein each said layer includes a plurality of molecular recognition sites,
and a three dimensional open-frame structure, which includes a plurality of molecular recognition sites.

3. A fuel cell as claimed in claim 2, wherein said supramolecule comprises a material selected from the group consisting of an octahedral-tetrahedral framework, a pyramidal-tetrahedral framework and a tetrahedral-tetrahedral framework.

4. A fuel cell as claimed in claim 1, wherein said anode material is an inorganic material.

5. A fuel cell as claimed in claim 1, wherein the molecular recognition sites recognize a fuel selected from the group consisting of fructose, galactose, glucose, lactose, mannose, sucrose, methanol, ethanol, propanol, butanol, tert-butanol and mixtures thereof.

6. A fuel cell as claimed in claim 1, wherein said anode material comprises:
a material selected from the group consisting of titanium, vanadium, chromium, manganese, iron, cobalt, nickel, copper, zinc, gallium, germanium, niobium, molybdenum, indium, tantalum, tungsten, compounds containing one or more of these metals and mixtures thereof; and
a complexing agent, which is selected from the group consisting of arsenic acid, boric acid, germanic acid, oxalic acid, phosphoric acid, silicic acid, calcium arsenate, potassium arsenate, sodium arsenate, sodium bromate, ammonium germanate, magnesium germanate, ammonium hexafluorogermanate, germanium oxide, ammonium phosphate, calcium phosphate, magnesium phosphate, potassium phosphate, sodium phosphate, sodium silicate, sodium tetraborate, sodium vanadate dihydrate, and mixtures thereof.

7. A process to prepare an anode material for a fuel cell comprising the steps of:
mixing a fuel, a complexing agent dissolved in a suitable solvent, and a material selected from the group consisting of metals, metal compounds and mixtures thereof to form a mixture;
heating said mixture to a suitable reaction temperature and for a suitable reaction time to form a metal complex in said mixtures;
cooling said mixture to form crystals in said mixture; and
separating said crystals from said mixture.

8. A process as claimed in claim 7, wherein said complexing agent is selected from the group consisting of arsenic acid, boric acid, germanic acid, oxalic acid, phosphoric acid, silicic acid, calcium arsenate, potassium arsenate, sodium arsenate, sodium bromate, ammonium germanate, magnesium germanate, ammonium hexafluorogermanate, germanium oxide, ammonium phosphate, calcium phosphate, magnesium phosphate, potassium phosphate, sodium phosphate, sodium silicate, sodium tetraborate, sodium vanadate dihydrate, and mixtures thereof.

9. A process as claimed in claim 7, wherein said complexing agent is selected from the group consisting of arsenic acid, oxalic acid, phosphoric acid, germanium oxide, potassium phosphate, sodium phosphate and sodium vanadate dihydrate.

10. A process as claimed in claim 7, wherein said solvent is selected from the group consisting of water, methanol, ethanol, propanol, butanol, azeotropes thereof and mixtures thereof.

11. A process as claimed in claim 7, wherein said metals are selected from the group consisting of titanium, vanadium, chromium, manganese, iron, cobalt, nickel, copper, zinc, gallium, germanium, niobium, molybdenum, indium, tantalum, tungsten, and said metal compounds contains at least one of these metals.

12. A process as claimed in claim 7, wherein said fuel is selected from the group consisting of fructose, galactose, glucose, lactose, mannose, sucrose, methanol, ethanol, propanol, butanol, tert-butanol and mixtures thereof.

13. A process as claimed in claim 12, wherein said fuel is glucose.

14. A process as claimed in claim 7, further comprising the step of:
activating said crystals by oxidation of said fuel in said crystals using a process selected from the group consisting of an electrochemical process, a thermal process and a mechanical process.

15. A process as claimed in claim 7, wherein said suitable reaction temperature is between 0° C. and 400° C.

16. A process as claimed in claim 7, wherein said suitable reaction time is between 1 hour and ten days.

17. An anode material for a fuel cell made using a process as claimed in claim 7.

18. An anode material for a fuel cell made using a process as claimed in claim 13.

19. A method to generate electricity comprising the steps of:
contacting a fuel with an anode which comprises sites which can interact with said fuel via molecular recognition sites on said anode;
contacting an oxidizing agent with a cathode which is in electrical contact with said anode via an electrolyte to generate an electric current.

20. A method as claimed in claim 19 further comprising the step of:
regenerating said molecular recognition sites on said anode.

21. A method to generate electricity claimed as in claim 19, wherein said fuel is glucose.

22. A method to generate electricity claimed as in claim 19, wherein said oxidizing agent is selected from the group consisting of air, oxygen and mixtures thereof.
